(19) United States
(12) Patent Application Publication
(10) Pub. No.: US 2012/0012029 A1
(43) Pub. Date: Jan. 19, 2012

(54) HIGH-PERFORMANCE ENVIRONMENTALLY FRIENDLY BUILDING PANEL AND RELATED MANUFACTURING METHODS

(75) Inventor: Rodrigo Vera, Delray Beach, FL (US)

(73) Assignee: Southern Cross Building Products, LLC, Boynton Beach, FL (US)

(21) Appl. No.: 13/245,293

(22) Filed: Sep. 26, 2011

Related U.S. Application Data
(62) Division of application No. 12/292,879, filed on Nov. 28, 2008, now abandoned.
(60) Provisional application No. 60/996,588, filed on Nov. 27, 2007.

(51) Int. Cl. C04B 14/22; C04B 14/04; C04B 2/00; C04B 14/18

(52) U.S. Cl. 106/15.05; 106/814; 106/698; 106/638; 106/801

(57) ABSTRACT

Various embodiments of a high-performance environmentally friendly building panel and related manufacturing methods are disclosed. Certain example embodiments described herein relate to various high-performance building panel configurations that utilize at least one engineered mixture produced with a desired thickness, shape and dimension, and manufactured through several preferential manufacturing methods. To selectively enhance some of the high-performance building panel characteristics such as its ability to withstand significant loads, mitigate possible contamination by bacteria growth, as well as its ability to be fire-retardant or fire-suppressant, and other credible operating scenarios the characteristics of different engineered mixtures may be combined during the panel forming process. Some of the manufacturing steps may involve sterilization and utilization of light-sensitive chemicals so as to sterilize as well as to enhance certain thermal-physical and mechanical characteristics of the high-performance building panel.

### CROSS REFERENCE TO RELATED APPLICATION

This application is a divisional of U.S. application Ser. No. 12/292,879, filed Nov. 28, 2008, which claims the benefit of U.S. Provisional Application Ser. No. 60/996,588, filed on Nov. 27, 2007, each incorporated herein by reference in its entirety.

### FIELD OF THE INVENTION

Certain example embodiments described herein relate to several distinct panel-forming mixtures and manufacturing unassembled elements which, when assembled, result in an efficient and cleaner manufacturing process dedicated to the production of functional, low-cost, highly-performing, and environmentally friendly building panels. More particularly, certain example embodiments described herein relate to various panel-forming mixtures and manufacturing configurations that may utilize multiple distinct mixtures comprising chemical elements which when combined, at the proper temperature and pressures, accurately and repeatedly generate an engineered mixture ready to be poured or pressure injected into a shape-forming and curing system. Once the engineered mixture is poured, or pressure injected, into an adjustable shape-forming and curing system it undergoes a series of processes wherein temperature and pressure may be controlled so as to optimize the production efficiency while maintaining the highest finished panel quality. Curing of the engineered mixture may begin from the moment it is poured, or pressure injected, into the shape-forming system by surface or in-depth exposure to controlled selective wavelengths of light, for example ultra-violet radiation, as well as other forms of radiation. Wavelength, intensity, and energy deposited by these various form of radiations may be adjusted so as to penetrate different thicknesses of distinct mixtures and selectively cure layers of the panel during formation and manufacturing. Exposure to these forms of radiation also sterilizes the high-performance building panel.

The distinct mixtures may be pre-mixed in mixture selecting and filtering tanks wherein active components such as, for example, electrical heaters, pressurizers, mixture positive displacement pumps, and stirring elements may be activated and monitored via specialized sensors. By actively controlling the thermodynamic parameters of the chemicals being mixed the speed at which the final construction board is being produced is fine tuned and optimized at all times, while obtaining a high quality and reliable product. Accurate and active control of the distinct mixtures improves their reaction rates and efficiency while assuring the generation of desired distinct mixtures densities and viscosities prior to being poured, or pressure injected, into the shape-forming and curing system.

### BACKGROUND AND SUMMARY OF EXAMPLE EMBODIMENTS OF THE INVENTION

Methods dedicated to the production of construction-panels with enhanced mechanical, fire resistant, and water proof characteristics have been known for several years. In some applications desired construction-panel geometries may be achieved by pouring various mixtures into fixed geometry forms wherein the mixture is uniformly spread with a controlled thickness, and allowed to cure for several hours. During the curing process the water in the mixture evaporates while permanent chemical bonds form and give the construction-panel desired material characteristics such as ability to withstand deformation, load, contamination, corrosion, and so on. In most of the methods adopted the curing process is executed at ambient pressures, temperatures, and humidity. Some of these mixtures comprise water mixed with magnesium oxide, magnesium chloride, wood shaving, perlite and other binding agents, as indicated, for example, in U.S. Pat. No. 7,255,907. Several of the final product physical characteristics depend on how these compounds are mixed, their relative percentage, and their curing time. In U.S. Pat. No. 7,255,907, for example, curing is executed under the variability and uncontrollability of environmental pressure and temperature conditions, and the addition of perlite in large proportions results in a final product generally very hard, brittle, difficult to cut, and with generally rough surfaces. In addition, the final product may need to be cured for several hours or days inside fixed forms. Variability of the weather conditions (i.e. sunny dry days versus high humidity rainy days) may result with variable enhanced or deteriorated mechanical characteristics of the final product also affecting the panel surface roughness, and stability of its shape. In some other applications fire-resistant fabrics or fiber meshes are applied to the surfaces of the construction panel while being formed resulting in a fire resistant barrier as indicated, for example, on US patent application publication No. 2006/0070321 A1. However, in some of these applications there is still uncertainty in their long-term stability as warping, or repeated cyclic stresses, impact, and so on can cause layers to separate and delamination of the layers exposed to the environment may occur. Some other mixtures include reactive materials such as metal oxide(s), phosphate(s), and residual materials to which may be added a reactive foaming agent so as to form lightweight composites as indicated, for example, on patent application publication No. US 2005/0252419 A1. The objective in this case is that of providing building materials with enhanced thermo-physical properties. In these cases controlling the expansion of the “reactive” mixture is difficult and maintaining a desired geometric shape during the curing of the mixture requires complex and expensive methodologies. In addition these manufacturing processes may produce large amounts of green-house gases.

Generally, products manufactured with high percentages of perlite are rigid and brittle, thereby prone to cracking, they are heavy and hard to cut, especially with a utility blade. In addition, prior art manufacturing methods require relatively long curing times.

Therefore, it will be appreciated that it would be beneficial to provide high-performance, environmentally friendly, lighter building panels, easier to cut, more resistant to mechanical stresses, and whose manufacturing processes require less curing time. In addition, the high-performance building panel of an example of the present invention is flexible as, for example, it may be used in contoured environments such as curved walls, substrate for paneling, siding, or roofing shingles, and for various applications, including marine applications.

The manufacturing methods described herein utilize recycled materials, and/or minimize, or eliminate, the usage of perlite or silicates, or other aggregates which may have negative environmental or health-related consequences. Materials as perlite, or other aggregates can be replaced by recycled glass (e.g., glass beads), and/or micro-sphere based or inert materials so as to reliably provide high-quality, cost-effective, and environmentally friendly building panels.

Therefore, the utilization of perlite may be reduced or eliminated by substituting it with recycled industrial glass, for example, made into a powder forms and mixed with certain engineered mixtures of the present invention. Alternatively, or in addition, recycled or engineered ceramic powder may be used. In this manner the resulting building panels show enhanced thermal-physical, mechanical, fire, water, and bacterial growth resistance characteristics. The methods described herein do not rely on fixed geometry forms as the engineered mixture, once brought to the desired thickness and proper rigidity, may be cut to adjustable shapes and dimensions, thereby allowing separation, and later curing in a racking system. In addition, the ambient conditions surrounding the now separated curing panel(s), cured when stationed within the racking system, may be controlled so as to enhance production rates, and quality assurance.

According to one example embodiment of the invention, there is provided a building panel comprising a core mix; and one or more fillers or binders, including at least about 2-3% by weight of glass. The glass may take the form of recycled glass beads.

According to another example embodiment of the invention, there is provided a building panel comprising a core mix; and one or more fillers or binders, including at least about 2-3% by weight of an anti-microbial or anti-fungal.

According to another example embodiment of the invention, there is provided a building panel comprising a core mix; and one or more fillers or binders, including little (e.g., less than about 3%) or essentially no Perlite.

According to another example embodiment of the invention, there is provided a building panel comprising a core mix; and one or more fillers and/or binders, including little (e.g., less than about 2%, or less than 1%) or essentially no silica. The core mix may comprise 70-85% by weight of the composition, with the balance in said fillers and/or binders. The core mix may comprise MgO and MgCl₂.

According to another example embodiment of the invention, there is provided an apparatus for manufacturing a building panel, comprising at least one main reactor including a plurality of tanks, each said tank including a tank mixture material; a mixer to receive the tank mixture material from each of the tanks and to provide a mixture of materials collected from all of the tanks; a conveyer surface to receive the mixture of materials from the mixer and to form the mixture into a board having a predetermined shape; a curing unit to receive the board from the conveyer surface; and a controller to control environmental processing conditions in the main reactor, the mixer and/or the conveyer.

According to another example embodiment of the invention, there is provided a method for manufacturing a building panel, comprising providing at least one main reactor including a plurality of tanks, each said tank including a tank mixture material; providing a mixer to receive the tank mixture material from each of the tanks and to provide a mixture of materials collected from all of the tanks; providing a conveyer surface to receive the mixture of materials from the mixer and to form the mixture into a board having a predetermined shape; providing a curing unit to receive the board from the conveyer surface; and controlling, via a controller, environmental processing conditions in the main reactor, the mixer and/or the conveyer.

According to certain example embodiments, a high-performance environmentally friendly building panel and related method are provided. The aspects and embodiments of this invention may be used separately or applied in various combinations in different embodiments.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a schematic illustration of a high-performance environmentally friendly building panel showing some simplified manufacturing steps in accordance with an example embodiment;

FIG. 2 is a simplified schematic illustration of selected manufacturing steps wherein the engineered mixture is poured, or pressure injected, onto a substantially flat surface in accordance with an example embodiment;

FIG. 3 is schematic illustrations showing the substantially flat surface with an inclinable slope in accordance with an example embodiment;

FIG. 4 is a schematic illustration of the high-performance environmentally friendly building panel manufacturing steps including the cutting, thickness fine adjustment system, and final curing processes by positioning the resulting high-performance building panel into an environmentally controlled racking system, in accordance with an example embodiment;

FIG. 5 is a schematic illustration showing multiple reactor mixers configured so as to combine distinct engineered mixtures forming layers to enhance the overall building panel material and mechanical properties, in accordance with an example embodiment;

FIG. 6 is a cross-sectional view of a simplified manufacturing method configuration including a continuous production method adopting a moving substantially flat surface wherein the engineered mixture is poured or pressure injected, in accordance with an example embodiment;

FIG. 7 is a cross-sectional view of a simplified manufacturing method configuration including a continuous production method adopting a moving substantially flat surface wherein the engineered mixture is poured or pressure injected into a controlled environment as the whole process occurs within temperature, pressure and humidity control, in accordance with an example embodiment;

FIG. 8 is a top view representation of a multilayer manufacturing process wherein layers can be shaped according to different patterns so as to achieve different mechanical, fire retarding or suppressing characteristics, in accordance with an example embodiment;

FIG. 9 is a representation of the surface of the high-performance building panel wherein by means of a special roller, or a dedicated form, a characteristic pattern, for example three-dimensional wood patterns, may be molded onto the building panel surface during the manufacturing processes, in accordance with an example embodiment;

FIG. 10 is a cross sectional schematic of a single or multilayered building panel wherein coated or un-coated micro-spheres may be part of the engineered mixture so as to enhance selected characteristics of the building panel, in accordance with an example embodiment; and,

FIG. 11 (Table 1) provides an example list of chemical elements in relation to one another and their ratio whose combination forms optimized engineered mixtures assembled, processed, and cured through various manufacturing methods to provide high-performance panels of different thicknesses and geometric dimensions, according to example embodiments.

### DETAILED DESCRIPTION OF EXAMPLE EMBODIMENTS OF THE INVENTION

The following description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

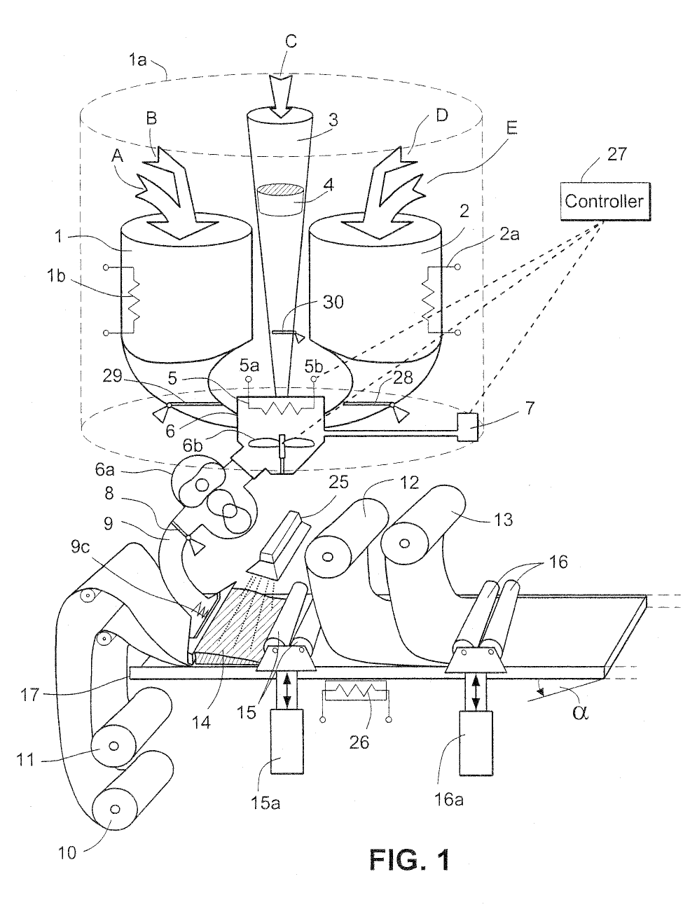

Referring now more particularly to the drawings in which like reference numerals indicate like parts throughout the several views, FIGS. 1-6 are schematic illustrations of a high-performance environmentally friendly building panel and related manufacturing methods in accordance with an example embodiment.

In FIG. 1, a preferential manufacturing method for the high-performance environmentally friendly building panel is shown. In this Figure a main reactor 1a represents a controlled chemical system wherein different chemical compounds may be mixed in distinct tanks 1, 2, and 3. Tank 1 may contain, for example, approximately 22% of MgCl₂ and H₂O, as indicated by A and B respectively. Tank 2 may contain MgO, as indicated by E, and recycled industrial glass, ceramic, or perlite powder as indicated by D. Tank 3 may contain additional mixing material such as spelt, recycled glass powder, ceramic powder, and micro-spheres as indicated by C. Mixing of compounds A, B, D and E is executed at proper pressure and temperature, e.g., about 68°-75° F., as well as filtering of impurities may be executed within their corresponding Tank (as shown in Tank 3 by filtering system 4). Temperature and pressures inside Tank 1 may be monitored with temperature sensors or transducers and pressure sensors or transducers, and controlled via computer and data acquisition system or controller 27, which may take the form of a general purpose computer. This computerized system may be configured to control and actuate one or more electrical heaters 1b so as to assure uniform temperature distributions, e.g., about 68°-75° F. within the mixture this tank contains. Similarly for Tank 2, actuation of one or more electrical heaters 2a assures uniform temperature distribution across the mixtures contained within the tank's inner walls. Tanks 1, 2, and 3 may be pressurized, e.g., about 14-25 psi, to avoid premature water evaporation at higher operating temperatures.

Once mixing of the distinct compounds A, B, C, D, and E in each separated tank is completed they are merged into a final mixer 6 wherein a stirring device 6b assures uniform blending at controlled temperature, e.g., about 72°-75° F., and pressures. Process temperatures inside final mixer 6 may be controlled by actuating one or more heating or cooling elements 5 (i.e. through representative leads 5a and 5b), e.g., about 68-75° F., while the pressure is controlled by a pressurizer 7, e.g., about 25-35 psi. Depending on the type of chemical reactions, once all of the distinct mixtures are blended, in some cases they may generate heat, in which case heat removal is required (i.e. via cooling coils, not shown in FIG. 1), in other cases the reactions require heat, in which case heating elements are activated (i.e. heating element(s) 5.

Pressurizer 7 may be configured to contain a controlled amount of water and full immersion heaters. Activation of the heaters causes pressurization of the final mixer 6 inner chamber. Alternative methods of pressurization (i.e. via positive displacement pumping device) may also be used. All of the active components are monitored and actuated by the computerized system 27.

Timely opening and closing of valves 28, 29, and 30 assures a desired ratio between distinct mixtures A+B, C, and D+E originally prepared in their distinct tanks 1, 3, and 2 respectively. The timely and calibrated opening of valves 28, 29 and 30 may be executed manually, or automatically. When the system operates in automatic mode these valves may be actuated by the computerized system 27. Inside final mixer 6 water content is also monitored to assure the viscosity, e.g., about 8,000-12,000 mPa of the resulting engineered mixture (A+B+C+D+E) is accurately controlled.

Once the engineered mixture is ready inside the final mixer 6 a positive displacement pumping system 6a is actuated. At the pumping system 6a suction, or inlet, the engineered mixture flows inside the pumping system by gravity and by pressure difference. Once inside the positive displacement pumping system 6a the engineered mixture is compressed to a controlled pressure, e.g., about 25-35 psi, and maintained at a pre-determined design pressure, e.g., about 30-35 psi. When valve 8 is actuated the engineered mixture flows inside diffuser 9. The inner walls of diffuser 9 may be actively heated (not shown in FIG. 1). When the pressure inside diffuser 9 reaches a proper threshold, e.g., about 35-45 psi, a spring-loaded gate 9c, acting as a check valve, begins opening and pouring or, depending on the manufacturing methods desired, pressure injecting a pre-shaped engineered mixture 14 onto layers of non-woven and fiber-glass materials positioned between a heated or cooled substantially flat surface 17 and the pre-shaped engineered mixture 14 by means of spools 10 and 11. The shape of the diffuser 9 outlet may be designed to provide the engineered mixture with a pre-shaped geometric form. Means to actively control and adjust the diffuser 9 outlet geometry may also be provided.

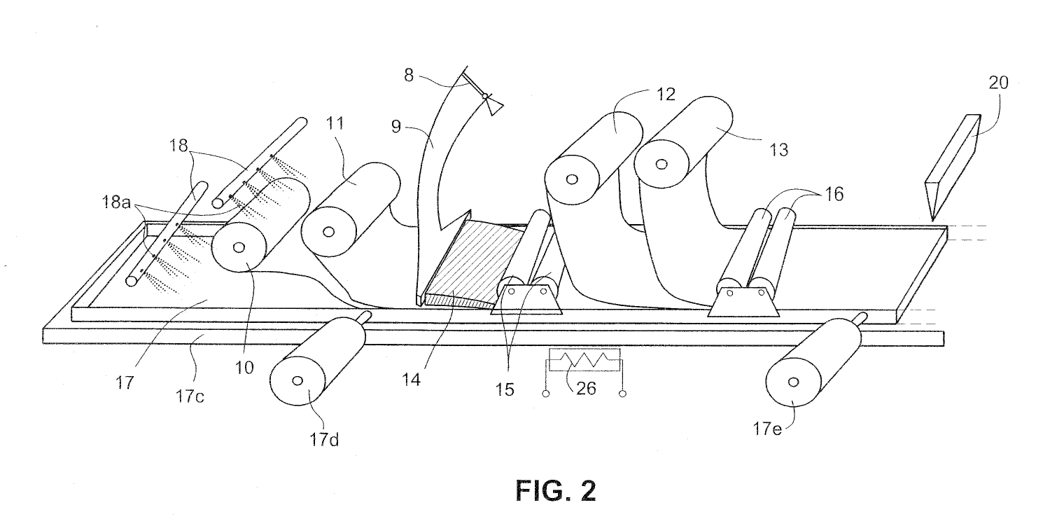

Curing of the pre-shaped engineered mixture 14 may be accelerated by regulating the temperature of the substantially flat conveyer surface 17, through actuation of properly distributed heating or cooling elements 26, as well as the temperature of rolls 15, and 16. These rolls may be equipped with active heating or cooling elements so as to assure uniform and constant pre-selected temperature on their surfaces. Although, not shown in FIG. 1 and in all other representation from FIG. 2-FIG. 6, the entire process may occur at a controlled environmental pressure and humidity, e.g., about 65-75% (absolute humidity), so as to counterbalance, for example, the increased water evaporation due to the adoption of reaction rate accelerating heaters. In addition, rollers 15 and 16 may increase or decrease the thickness of the pre-shaped engineered mixture 14 by actuation of systems 15a and 16a wherein their position may be hydraulically, motor, or electromagnetically actuated, for example via computerized system 27.

Tank 3 may also provide the engineered mixture with light-radiation-sensitive compounds which may be used to change shape or density when irradiated. In this case, while the pre-shaped engineered mixture 14 is poured or pressure injected onto the non-woven and fiber-glass layers properly positioned onto the substantially flat heated surface 17, a source 25 emitting light at proper wavelength, e.g., about 750-900 nm, may irradiate the pre-shaped engineered mixture 14. In this manner the pre-shaped engineered mixture 14 curing can be made so as to selectively enhance certain physical and thermal characteristics of the final product and provide a very high-performance and environmentally friendly building panel.

Source 25 may also represent an electron beam radiation source so as to irradiate and sterilize the engineered mixture.

After the first set of active rollers 15 additional layers of non-woven and fiber-glass materials are positioned onto the pre-shaped engineered mixture 14 by means of spools 12 and 13. Final thickness adjustments may be accomplished by active rollers systems 16. Temperature on the surfaces of rollers 16 may be regulated, e.g., about 75°-80° F., so as to “melt” or increase bonding of different materials (i.e. other than fiber-glass) onto the pre-shaped engineered mixture 14.

The substantially flat temperature controlled surface 17 may be stationary or movable and it can move at the same speed of the moving pre-shaped engineered mixture 14, or at different speeds.

The substantially flat temperature controlled surface 17 may also be inclined by a desired angle indicated by a with respect to the horizon so as to use the aid of gravity force when the process involves, for example, engineered mixtures with high viscosity.

A preferential high-performance environmentally friendly building panel manufacturing method is shown in FIG. 2. In this representation the engineered mixture 14 is poured or pressure injected onto a stationary or movable substantially flat heated or cooled surface 17. Active and fine dimensioning of the pre-shaped engineered mixture 14 may be achieved by actuating side actuators 17d and 17e. The system is symmetrical and the process is equipped with similar actuators on both sides (for simplicity not shown in FIG. 2). To avoid adherences of the surface materials utilized to cover the pre-shaped engineered mixture 14 a lubricating system 18 may provide lubricating or reactive, curing, fluids 18a directly on the substantially flat heated or cooled surface 17 and/or on the spools 10 or 11. Controller 27 may provide a control signal to activate system 18, e.g., by monitoring, via a proximity sensor, whether the mixture 14 has been deposited or injected onto surface 17, and controlling the system 18 to apply fluid to the surface for a predetermined period of time or until such time as the mixture is applied to the surface.

The computerized system 27 of FIG. 1, may control and actuate cutting blade 20 so as to cut the curing high-performance building panel with adjustable and desired dimensions. The substantially flat heated or cooled flat surface 17 may be configured so as to slide over a fixed surface 17c and move at speeds proportional to that of the poured or injected engineered mixture 14.

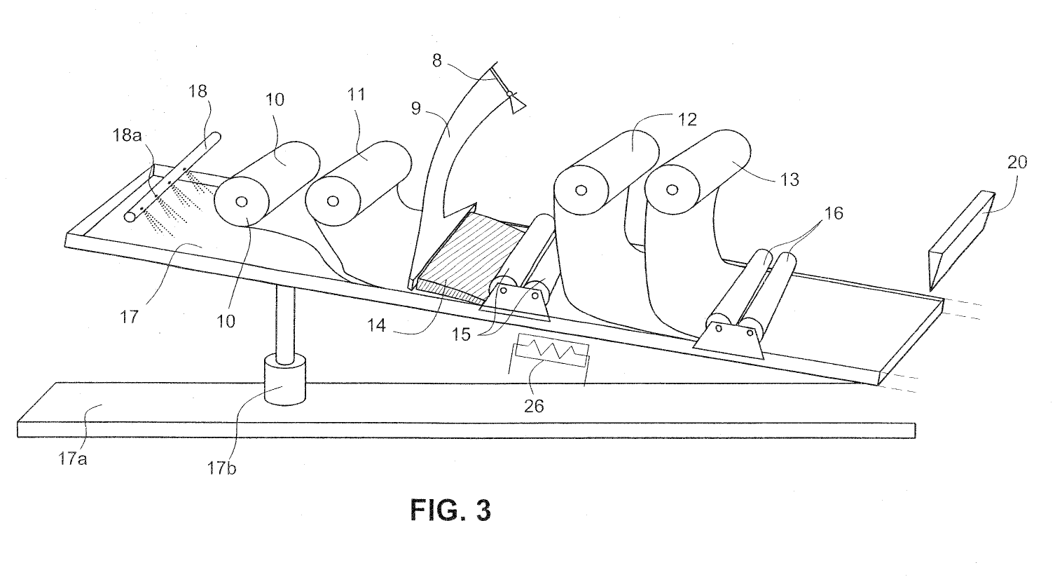

In FIG. 3 another manufacturing method similar to that described in FIG. 2 is shown. In this figure the substantially flat heated or cooled surface 17 may be stationary with respect to the poured or pressure injected pre-shaped engineered mixture 14, however, it may be inclined with different slopes as determined by actuation of actuator 17b. In this case the pre-shaped engineered mixture 14 may show different degrees of viscosity, for example, to satisfy the requirements of specialized applications.

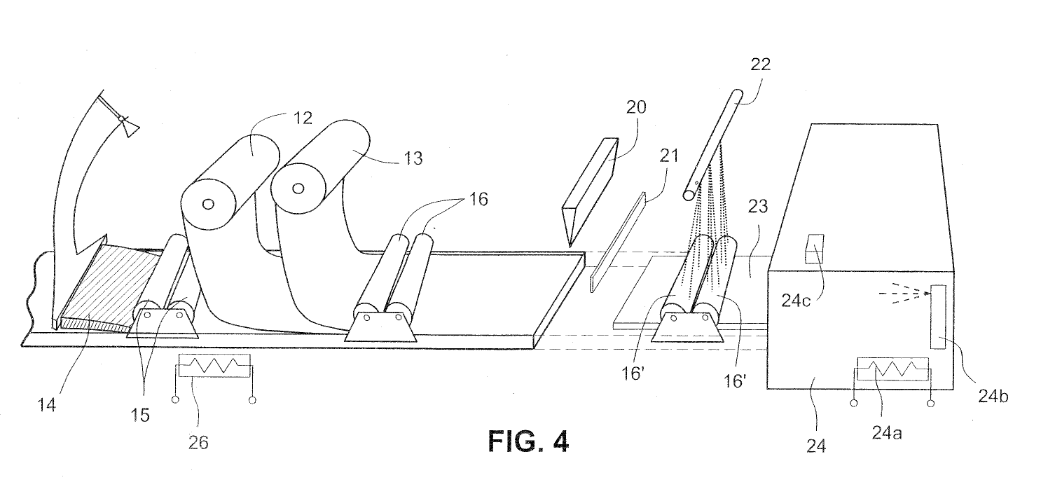

In FIG. 4 the final process steps of a preferential high-performance building panel manufacturing method are shown. In these steps, the high-performance panel obtained by processing the pre-shaped engineered mixture 14 is advanced and an “end strip” 21 of proper materials, e.g., extruded graphite, is placed at the edge of the building panel prior to its final thickness check by means of active rollers 16′ and relative lubricating or curing fluids sprayed by sprayer 22, and prior to the building panel 23 entering a controlled racking system positioned within a controlled environment chamber 24. Heat, humidity and pressure are actively controlled, for example, by means of drying heaters 24a, steam generators 24b, and a pressurizer 24c, e.g., pressure is maintained up to about 40 psi.

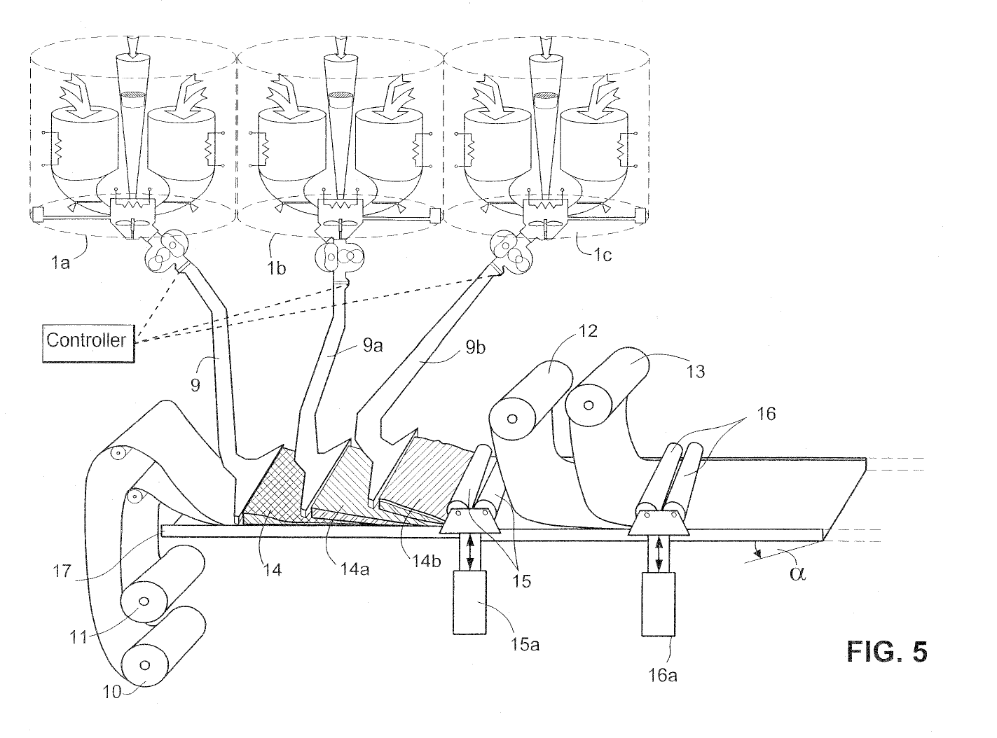

In FIG. 5 a preferential method for the manufacturing of highly-performing, environmentally friendly universal building panels is shown. In this figure more than one reactor 1a (as shown in FIG. 1) is employed so as to create two or more distinct layers as an integral part of a single building panel. This method considers three distinct reactors 1a, 1b, and 1c, however it can use two or more than three. In this preferential building panel manufacturing method reactor 1a may be configured to pour or pressure inject a distinct engineered mixture 14, designed to provide extremely resilient characteristics, for example, in terms of rigidity, or fire resistance, or others. Reactor 1b may be configured to pour or pressure inject a different and distinct engineered mixture 14a designed, for example, to provide significant impact resistance characteristics, or show high levels of flexibility, or with extremely low thermal conductivities. Finally reactor 1c may be configured to pour or pressure inject a distinct engineered mixture designed, for example, to be water proof or with characteristics identical to those provided by the engineered mixture 14 provided by reactor 1a. The thicknesses of each layer may be adjusted by changing the pouring or pressure injection rates of each distinct diffuser 9, 9a, or 9b with respect to each other, thereby provide the means to manufacture a building panel accurately engineered to meet selected specifications. In this configuration positioning of one or more radiation sources 25 (as shown in FIG. 1) may allow curing of one or more selected layers of engineered mixtures 14, 14a, or 14b.

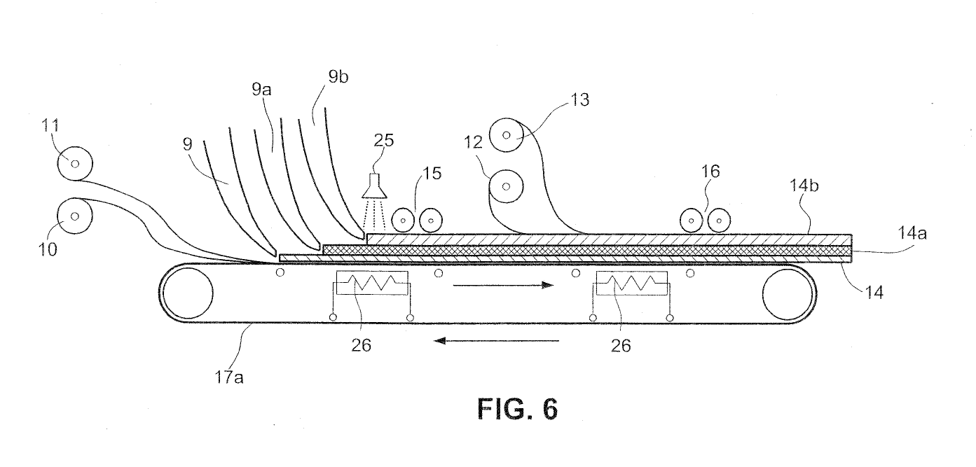

In FIG. 6 a preferential high-performance building panel manufacturing method is shown. In this embodiment the substantially flat heated or cooled surface 17a is movable by means of a properly designed endless belt for a high-rate continuous production line. The features described in the various embodiments of FIG. 1 to FIG. 5 also apply to the preferential method of FIG. 6. The thickness of layers of pre-shaped engineered mixtures 14, 14a, and 14b is arbitrary. Radiation source 25 may also be positioned between diffusers 9, 9a, and 9b so as to expose each distinct engineered mixture to different or similar radiation intensities as required for different applications.

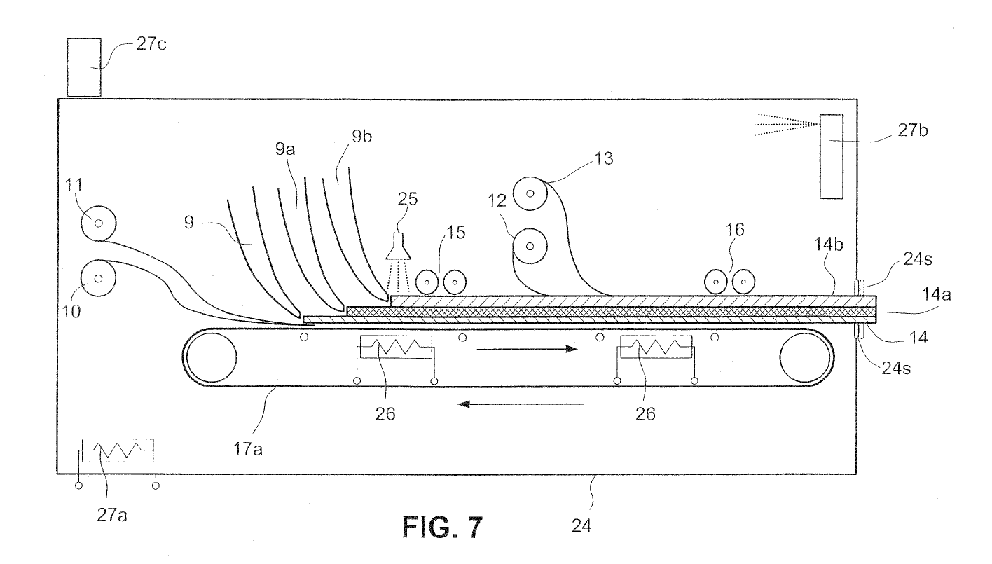

In FIG. 7 the preferential high-performance building panel manufacturing method described in FIG. 6 is further optimized by means of a system 24 configured to control the pressure, e.g., about 35-40 psi, temperature, e.g., about 68°-75° F., and humidity, e.g., about 50-65% absolute humidity, of the engineered mixture after it has been poured or pressure injected. In this manner evaporation and curing time may be optimized while assuring the highest quality and reliability of the final product. In this FIG. 27c represents a pressurizer able to pressurize or depressurize, e.g., in the range of about 20-40 psi the ambient surrounding the building panel during manufacturing. A heating or cooling system 27a is configured to maintain the temperature of the environment surrounding the engineered mixture at desired values, e.g., about 68°-75° F., while the engineered mixture is being processed. System 27b represents a control mechanism assuring that proper humidity is maintained during manufacturing. Seals 24s may be made of flexible membranes assuring minimum fluid leakage in or out of the controlled environment included within system 24.

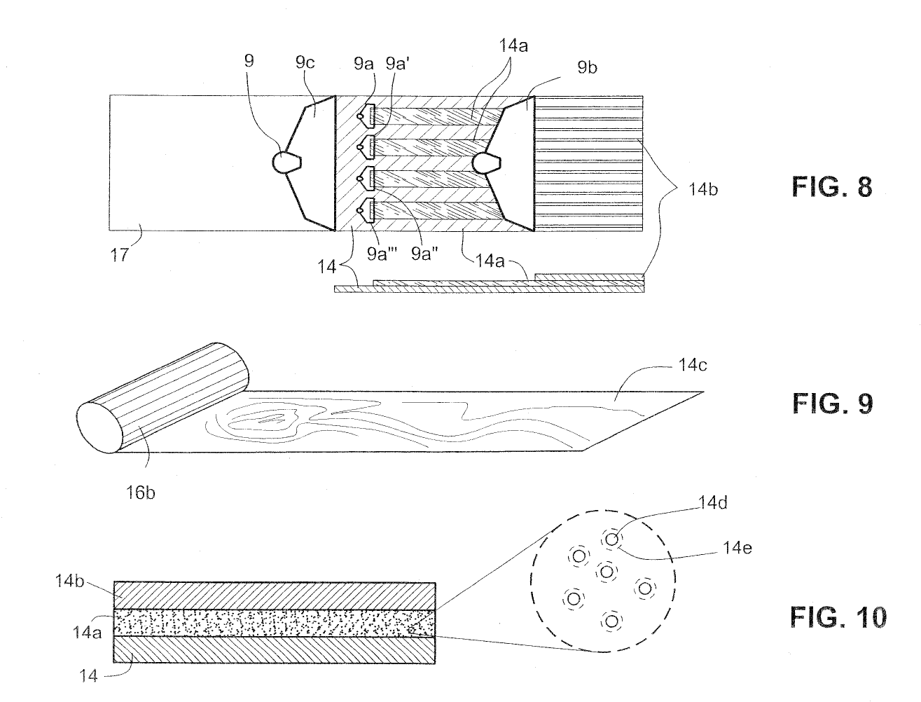

FIG. 8 is a top-view representation of one or multiple layers of the engineered mixture after being poured or pressure injected onto the substantially flat surface 17. In this Figure the diffuser 9 positions a pre-shaped layer of a first engineered mixture, one or more axially spaced diffuser(s) 9a position(s) another pre-shaped layer of a second engineered mixture, and diffuser 9b positions another pre-shaped layer of a third engineered mixture. First, second and third engineered mixtures may be distinct or the same. By changing the shape of diffuser 9a, for example by reducing its pre-shaped engineered mixture outlet a series of patterns may be created within the building panel. In this manner a more rigid mixture may be formed in the central layer of the building board, while more flexible engineered mixtures may be used on the layers exposed to the environment.

FIG. 9 provides an example of a method utilized to shape the surface exposed to the environment with an artificial wood grain or other desired patterns. In this figure a roller 16b whose surface has been three-dimensionally modified may be used to press the building panel during the manufacturing process so as to obtain a non-glossy surface. A similar result may be obtained by using a pre-molded shape onto the substantially flat surface 17.

FIG. 10 indicates a multilayered building panel wherein the inner layer 14a is formed by coated or uncoated micro-spheres 14d. These micro-spheres have multiple purposes as they may be hollow so as to decrease the building panel thermal conductivity, thereby increasing the building panel insulation properties. The micro-spheres may be filled with a fluid or a solid substance whose contact with a flame may release fire retardant and fire suppressant chemicals. The micro-spheres may be coated with a substance 14e which makes the micro-sphere's material un-reactive with the rest of the engineered mixture A, B, C, D and E shown in FIG. 1. The micro-spheres may also be un-coated so as to favor chemical reactions with the other chemical components forming the engineered mixtures.

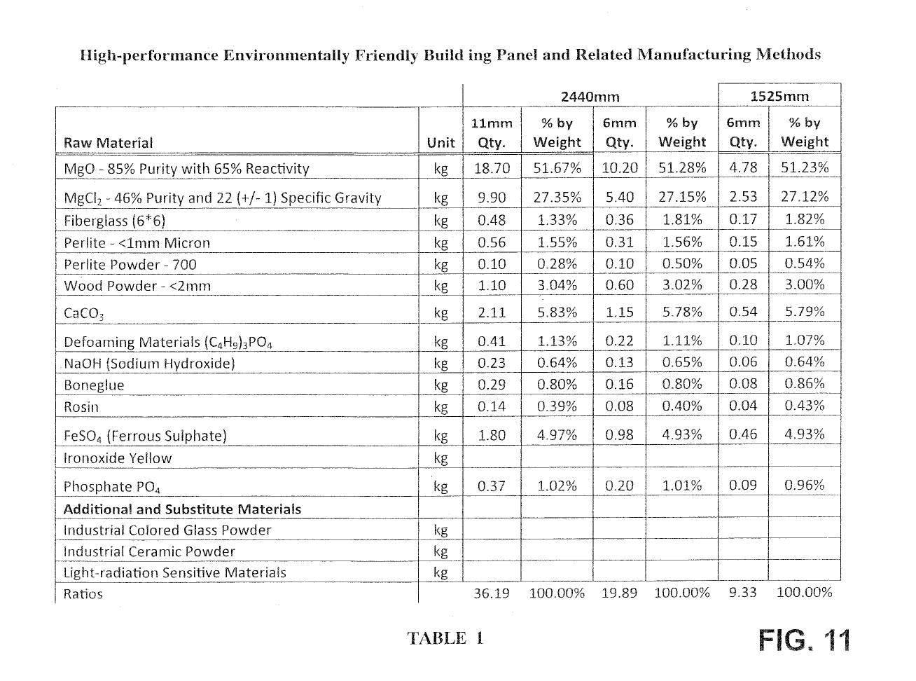

An example of a list of chemicals or components utilized to prepare selected engineered mixtures (i.e. 14 in FIG. 1, or 14a, 14b in FIG. 5 and FIG. 6) according to the embodiments of this invention are represented in FIG. 11 (Table 1). As shown in Table 1 the chemicals are mixed according to selected ratios and are referenced to high-performance building panels of different thicknesses (e.g., 11 mm or 6 mm) and dimensions (e.g., 2440 mm or 1525 mm length). The specific composition of each component may be varied by up to +/−5-10%. In both tables under the “Raw Material” list, perlite powder and/or wood powder may be substituted with industrial recycled glass or glass beads (which may be colored), ceramic powder, light-radiation sensitive materials, and/or coated or uncoated micro-spheres.

In one example the wall board composition includes a core mix including two or more basic ingredients, such as MgO and MgCl₂, sometimes referred to as “mud”, as well as one or more fillers or binders (or substitutes) listed. The core mix may comprise about 70-85% of the entire mixture, while the balance (about 15-30%) includes the fillers, binders and/or substitutes. In one example, the one or more binders may include glass beads and/or an antimicrobial (e.g., Microban or Durban). The glass beads or the antimicrobial/anti-fungal may comprise about 2-3% of the entire composition, and they may be a substitute for wood powder.

In addition, the composition may be formulated without or substantially without silica or Perlite. In particular, the Perlite powder and/or Perlite (<1 mm) content can be set to less than 3%, between about 2-3%, or less than about 2%. The silica can be set to be less than about 2%, or less than 1%, but preferably less than about 0.05%, or preferably about 0%.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A building panel comprising:
a core mix; and
one or more fillers or binders, including at least about 2-3% by weight of glass.

2. The building panel of claim 1, wherein the glass takes the form of recycled glass beads.

3. A building panel comprising:
a core mix; and
one or more fillers or binders, including at least about 2-3% by weight of an anti-microbial or anti-fungal.

4. A building panel comprising:
a core mix; and
one or more fillers or binders, including little or no Perlite.

5. A building panel comprising:
a core mix; and
one or more fillers and/or binders, including little or no silica.

6. The building panel of claim 5, wherein the silica comprises no more than about 2% by weight of the composition.

7. The building panel of claim 5, wherein the core mix comprises 70-85% by weight of the composition, with the balance in said fillers and/or binders.

8. The building panel of claim 5, wherein the core mix comprises MgO and MgCl₂.

9. The building panel of claim 5, wherein the fillers and/or binders include a light-radiation-sensitive compound.

10. The building panel of claim 5, further comprising microspheres.

11. The building panel of claim 10, wherein the microspheres may be coated or uncoated and filled or unfilled.
